(19) United States
(12) Patent Application Publication
(10) Pub. No.: US 2009/0100017 A1
(43) Pub. Date: Apr. 16, 2009

(54) Method and System for Collecting, Normalizing, and Analyzing Spend Data

(75) Inventors: Bruce Clark Graves, Yorktown Heights, NY (US); Steven J. Mitchell, Bethel, CT (US); Karyn Joy Schneider, Carroll, OH (US); Craig Richard Selinger, Monsey, NY (US); Debora Ann Villella, North Myrtle Beach, SC (US)

Correspondence Address: DUKE W. YEE;YEE & ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 11/871,619

(22) Filed: Oct. 12, 2007

(51) Int. Cl. G06F 17/30

(52) U.S. Cl. 707/3; 707/E17.014

(57) ABSTRACT

A system for processing spend data. In response to capturing data feeds from one or more clients and a service provider, spend data contained within the data feeds is normalized by mapping the spend data to a common universal taxonomy using a business rule set. The normalized spend data is stored within an aggregated spend database. Report queries are run against total aggregated spend data within the aggregated spend database. Then, results of the report queries are posted on a secure web portal for viewing by authorized users.

### BACKGROUND OF THE INVENTION

1. Field of the Invention

The present invention relates generally to an improved data processing system. More specifically, the present invention is directed to a computer implemented method, system, and computer usable program code for collecting, normalizing, and analyzing spend data in support of a multi-client procurement services outsourcing environment to drive cost savings.

2. Description of the Related Art

Today, enterprise organizations embark on strategies to improve buying power, or “leverage,” with their supplier base to ensure competitive, lower prices for goods and services. In addition, these enterprise organizations embark on strategies to assure adequate supply, especially in constrained situations, and to improve quality and service levels. In other words, these enterprise organizations embark on these strategies in order to get the most value out of the dollars invested.

With increased commoditization of goods and services, an enterprise's advantage over the competition often narrows. Consequently, any advantage on the open market, even a small one, may be critical to an enterprise within this tightened competitive environment. In the past, use of proprietary designs, parts, and services often provided an enterprise's procurement organization with a reduced set of supplier choices and, therefore, a built-in differentiated goods and services product line from the competition. To reduce costs and improve supply chain effectiveness, increased use of industry standard designs, parts, and services has increased competition and reduced buying power and price influence with major enterprise suppliers. With the advent of the Internet, suppliers and customers are now competing on a global basis, adding more open competitiveness within the system.

Only the most mature enterprise procurement organizations are advanced to the point where they have good visibility to all spend across an enterprise from which to leverage savings. Those enterprise procurement organizations that do not seek to outsource both the transformation and operation of their indirect, or non-production, spend as a means to optimize operating expenses, while simultaneously reaping procurement savings through enhanced sourcing opportunities, will be at a significant disadvantage in the tightened competitive environment.

One possible solution to this tightened competitive environment may be to enhance the enterprise relationship through, for example, longer term supplier contracts or though enterprise partnerships. However, this enhanced enterprise relationship reduces flexibility and lengthens response time to changes in economic conditions. Another possible solution may be to increase the volume of buying, thereby increasing a buyer's influence upon the enterprise supplier's price point. However, this latter solution is limited to the volume of items or services that the buying enterprise will consume. In addition, this latter solution has a limitation to the volume of goods and services that the purchasing enterprise will consume in a reasonable period of time. For example, if an enterprise purchases a larger volume, such as buying a ten year supply, then the enterprise incurs higher carry covers, increased risk of obsolescence, and, if future prices are reduced, lost opportunity to enjoy these lower prices since the items already had been purchased at a higher cost. Also, in order to enable a comprehensive view of all managed spend, the latter solution requires a common universal taxonomy to classify the common spend across multiple business enterprises, which does not currently exist today.

Therefore, it would be beneficial to have an improved computer implemented method, system, and computer usable program code for collecting, normalizing, and analyzing spend data in support of a multi-client procurement services outsourcing environment to drive cost savings.

### BRIEF SUMMARY OF THE INVENTION

Illustrative embodiments provide a computer implemented method, system, and computer usable program code for processing spend data. In response to capturing data feeds from one or more clients and a service provider, spend data contained within the data feeds is normalized by mapping the spend data to a common universal taxonomy using a business rule set. The normalized spend data is stored within an aggregated spend database. Report queries are run against total aggregated spend data within the aggregated spend database. Then, results of the report queries are posted on a secure web portal for viewing by authorized users.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is an exemplary illustration of a spend taxonomy normalization system in accordance with an illustrative embodiment; and

FIG. 4 is a flowchart illustrating an exemplary process for collecting, normalizing, and analyzing spend data in accordance with an illustrative embodiment.

### DETAILED DESCRIPTION OF THE INVENTION

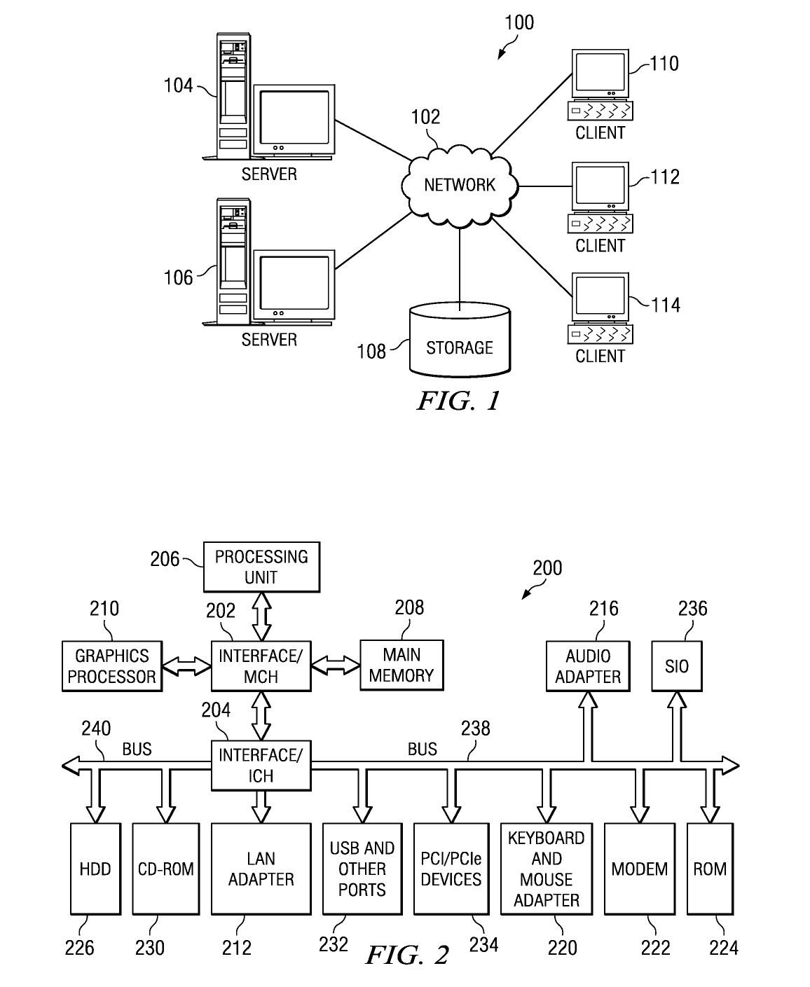

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. It should be noted that servers 104 and 106 represent a plurality of server devices, such as, for example, a staging server, a processing server, and a reporting server, among other servers not listed. In addition, clients 110, 112, and 114 represent an unlimited number of client devices, which also connect to network 102. Clients 110, 112, and 114 may be, for example, personal computers or network computers. Also in the depicted example, server 104 provides data, such as boot files, operating system images, and applications to clients 110, 112, and 114. Moreover, clients 110, 112, and 114 are clients to server 104 in this example. Further, storage 108 is a database server within network data processing system 100. Furthermore, network data processing system 100 may include additional servers, clients, other devices, and connectivity not shown.

In the depicted example, network data processing system 100 is the Internet with network 102 representing a worldwide collection of networks and gateways that use the transmission control protocol/internet protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including interface and memory controller hub 202 and interface and input/output (I/O) controller hub 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to interface and memory controller hub 202 through an accelerated graphics port (AGP), for example.

In the depicted example, local area network (LAN) adapter 212 is coupled to interface and input/output controller hub 204 and audio adapter 216, keyboard and mouse adapter 220, modem 222, read only memory (ROM) 224, universal serial bus (USB) and other ports 232, and PCI/PCIe devices 234 are coupled to interface and input/output controller hub 204 through bus 238, and hard disk drive (HDD) 226 and CD-ROM 230 are coupled to interface and input/output (I/O) controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). HDD 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™. Microsoft and Windows Vista are trademarks of Microsoft Corporation in the United States, other countries, or both. An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as HDD 226, and may be loaded into main memory 208 for execution by processing unit 206. The processes of the illustrative embodiments may be performed by processing unit 206 using computer implemented instructions, which may be located in a memory such as, for example, main memory 208, ROM 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a smart phone or other pervasive computing device or a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or smart phone device in addition to taking the form of a PDA.

Illustrative embodiments provide a computer implemented method, system, and computer usable program code for processing spend data. In response to capturing data feeds from one or more clients and a service provider, a spend taxonomy normalization tool normalizes spend data contained within the data feeds by mapping the spend data to a common universal taxonomy using a business rule set. The spend taxonomy normalization tool stores the normalized spend data in an aggregated spend database. In addition, the spend taxonomy normalization tool runs report queries against total aggregated spend data within the aggregated spend database. Moreover, the spend taxonomy normalization tool posts results of the report queries on a secure web portal for viewing by authorized users.

Spend data is data relating to the amount of money a client enterprise spends on procuring outsourced goods and services from external suppliers. Spend data may also include other information, such as supplier reference data. Supplier reference data may, for example, include commodity codes, currency data, supplier data, geography data, client hierarchy data, payment term data, contract data, and client spend forecast data.

Commodity codes represent goods and services developed in a hierarchical structure to allow for consolidating spend across clients at various levels. An example is contracted services. Contracted services may be viewed at a high level or broken down into the type of contracted services being procured, such as software developers, engineering services, administrative services, etc. Currency data represents currency conversion tables that are used in the process of loading spend information from the clients, as well as the service provider. The ability to normalize spend data into a standard currency allows for price comparison and aggregation of consolidated spend in a single currency for negotiations.

Supplier data normalization is a critical component in determining savings opportunities. Names and addresses of suppliers for all clients, as well as the service provider, are stored within an aggregated spend repository. On, for example, a monthly basis this supplier data file may be processed to identify where the supplier is identical, as well as linkage of suppliers to the parent corporation. Armed with this information, sourcing strategies may be formed to drive preferred supplier relationships, multi-client agreements, and opportunities to leverage additional savings across the portfolio of clients.

Geography data is another hierarchical taxonomy that allows authorized users to view spending patterns across countries, regions, and other geographies. Consolidation of local spending or broadening that local spending to international suppliers may generate additional savings. Payment term data provides another area for savings opportunity. The payment term is the length of time between receipt of an invoice and when payment is due. Negotiation of a more favorable payment term may lead to additional savings opportunities with regard to the time value of money.

Contract data is spending that is currently associated with a contract and is maintained in the aggregated spend repository. Known linkages from individual client contracts to the multi-client agreements are necessary to track compliance, as well as understanding current flexibility in making changes to either source or price. Forecast spend data by each client are contained within special tables within the aggregated spend repository, which provides the ability to consolidate future needs of all clients, along with their known spending patterns.

Thus, illustrative embodiments improve client negotiating positions with suppliers by automatically integrating spend and supplier reference data of multiple client enterprises with varying spend classification taxonomies received from varying client support system infrastructures. In addition, illustrative embodiments provide a comprehensive spend visibility across multiple outsourced procurement clients to leverage in support of sourcing strategies for the clients. Further, illustrative embodiments allow assimilation of spend data from multiple diverse and disparate client enterprises into a single data repository, which is normalized to a common universal taxonomy. Commonly used spend reports can be automatically generated from this stored normalized data and posted on a web portal and used to increase cost savings. Furthermore this data can also be used for data mining by strategic sourcing experts on behalf of these client enterprises to increase cost savings.

This single spend data repository is leveraged on behalf of all clients, including the service provider, in the development and implementation of sourcing strategies based on the collective spend patterns of all clients under contract. Illustrative embodiments capture each client's spend, supplier, and reference data components and map this captured data to an equivalent universal baseline taxonomy, or classification of data, as recognized by the outsourced service delivery provider. This mapping is stored in the system applications as “business rules” against which all future transactional spend feeds are normalized for a respective client. This normalization process is completed for each client under contract to ensure complete capture of all managed spend by the outsourced service delivery provider, to enable a comprehensive view of all managed spend for leverage in sourcing strategies, from which savings opportunities are mined and ultimately presented to clients for implementation.

Procurement services clients may be subdivided into two or more groups. The first group are clients that, as part of an outsourced procurement business transformation contract, elect to migrate their system's infrastructure to an integrated source-to-pay (S2P) system as developed and implemented by the services provider. The second group are clients that, as part of an outsourced procurement business transformation contract, elect to remain on their existing system's infrastructure. However, illustrative embodiments assimilate all client groups into the normalization system with the only significant variation between the two client groups being the source systems from which spend data is derived.

While there are initial savings opportunities to be identified through leveraging spend across a single client's organization, another set of savings opportunities lie in harnessing the spend of the service provider and the service provider's multiple clients. Absent an aggregated spend data repository, the spend of the service provider and individual clients may be viewed as fragmented parts of a larger whole. However, combined into a single data repository, in a common normalized taxonomy, spend data from across multiple enterprises may be queried, for example, to uncover spending patterns in similar categories, total spend with the same supplier, and opportunities to further consolidate suppliers and spend data. This information may then be used to begin moving sourcing strategies, preferred supplier relationships, and sourcing recommendations to the next level and provide the opportunity to leverage additional savings.

As a result, buyers armed with this consolidated and centrally available information may support the end-to-end engagement cycle by: 1) extrapolating historical spend and savings results and providing this information to procurement services deal teams seeking to win new client business; 2) demonstrating to suppliers, in real terms versus estimated spending figures, the true spending potential, and thus savings potential, of the service provider and its clients within various categories; 3) entering into negotiations with solid data regarding historical spend and patterns, as well as spend forecasts for the future; 4) extending preferred supplier relationships into formal contractual pricing arrangements known as multi-client agreements, which extend best-in-class pricing to the service provider and its clients; and 5) providing continued price leverage and savings benefits to the service provider and its clients via visibility to increasing spend levels as more clients are added to the portfolio and more managed spend is driven through multi-client agreements.

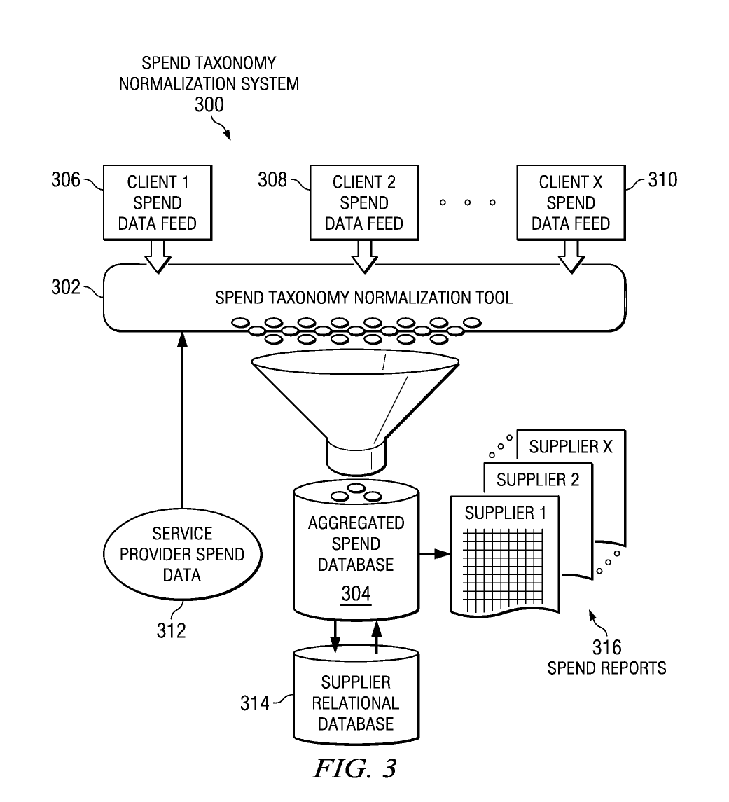

With reference now to FIG. 3, an exemplary illustration of a spend taxonomy normalization system is depicted in accordance with an illustrative embodiment. Spend taxonomy normalization system 300 may, for example, be implemented in network data processing system 100 in FIG. 1. Spend taxonomy normalization system 300 represents a high level view of a multi-client procurement services outsourcing environment that is connected via a network, such as network 102 in FIG. 1. Spend taxonomy normalization system 300 provides spend normalization for the totality of clients' total spend available as managed spend across the totality of the procurement services outsourcing business environment, as well as the opportunity to include the spend of the service provider, and yields a comprehensive view of the managed spend when combined with the service provider's spend.

Each client in the multi-client procurement services outsourcing environment submits a spend data feed in their own native taxonomy, which is automatically normalized to an equivalent universal baseline taxonomy as recognized by the outsourced service delivery provider, to enable a comprehensive view of all managed spend for leverage in sourcing strategies. These sourcing strategies include the development of multi-client agreements whereby negotiations with participating suppliers drive “best in class” pricing based on total spend volume committed to respective participating suppliers. In this particular example of FIG. 3, a “spend by supplier” view is shown as queried from the resultant aggregated spend data repository. However, it should be noted that additional views may also include, but are not limited to: spend by client, spend by geography, spend by commodity, annual spend and spend by quarter.

Spend taxonomy normalization system 300 includes spend taxonomy normalization tool 302. Spend taxonomy normalization tool 302 may, for example, be located in a server, such as server 104 in FIG. 1. Alternatively, taxonomy normalization tool 302 may be located in aggregated spend database 304.

Spend taxonomy normalization tool 302 is a software tool that may include several components, such as, for example, a common data application and information management software. Spend taxonomy normalization tool 302 is designed to collect, normalize, and analyze spend data from a plurality of clients, such as clients 110, 112, and 114 in FIG. 1. Spend taxonomy normalization tool 302 collects this spend data by capturing data feeds, such as client 1 spend data feed 306, client 2 spend data feed 308, and client X spend data feed 310, from the plurality of clients. It should be noted that spend taxonomy normalization tool 302 may accept and capture client data feeds on a continuous real time basis, on a periodic scheduled basis, or on demand. In addition, spend taxonomy normalization tool 302 may add new client data feeds on the fly at any time.

Further it should be noted that spend taxonomy normalization tool 302 may receive the data feeds using, for example, secure file transfer protocol (SFTP) to a secure drop box, which may be a UNIX directory capable of receiving such data. However, spend taxonomy normalization tool 302 may utilize additional transmission/reception methodologies that include, but are not limited to, file transfer protocol (FTP), MQ Series®, and direct server to server communication.

After capturing client 1 spend data feed 306, client 2 spend data feed 308, and/or client X spend data feed 310, spend taxonomy normalization tool 302 normalizes the different spend data taxonomy nomenclatures found in the various client feeds. Normalization is the process of standardizing the various and disparate client formats and nomenclatures into one common universal taxonomy, which is also utilized by the service provider, so that all collected data is classified in the same way for proper analysis and interpretation. A common format for the normalized data may, for example, be extensible markup language (XML). However, additional formats for the normalized data may be used, such as, for example, flat file, Database 2 (DB2) database, and Oracle database.

Spend taxonomy normalization tool 302 normalizes these client spend data feeds by mapping the captured client spend data to a universal taxonomy nomenclature using a set of business rules, which may include a set of self-learning rules. For example, a business rule may state that the client's commodity code “123” equates to universal commodity code “XYZ” as derived from the respective client's reference data set. Every time spend taxonomy normalization tool 302 reads commodity code “123” it is automatically converted to universal commodity code “XYZ”. Therefore, a business rule in this context may be defined as the universal taxonomy equivalent of the respective client's reference data component baseline (i.e., “123”=“XYZ”).

Conversely, “self-learning” rules may be defined as those spend data elements that were not included in the client's initial reference data baseline, but are subsequently discovered in ongoing spend data feed normalization iterations. These spend data elements “fall out” of spend taxonomy normalization tool 302 and are forwarded to a resource center for manual correction. For example, if client's commodity code “888” is not recognized in the pre-defined business rules for the respective client as derived from their initial reference data baseline, it is mapped to its universal equivalent (e.g., “ZZZ”) by the resource center team and added to the set of pre-defined business rules for the respective client. Thereafter, every time commodity code “888” is recognized by spend taxonomy normalization tool 302 it will be automatically mapped to its universal equivalent (“ZZZ”) as defined by the resource center team and populated in the business rules set for the respective client. Another example may be the ability to understand, for example, that all of the following company names are the same as, and are mapped to, “ABC”: “A.B.C.”, “ABC.”, “ABC Corp”, “A.B.C. Corp”, and “Advanced Business Computers”.

Spend taxonomy normalization system 300 also includes aggregated spend database 304. Aggregated spend database 304 may, for example, be storage 108 in FIG. 1. Aggregated spend database 304 is a database that stores aggregated spend data and is designed to be fully scalable. The design in scalability is for both increased amounts of data efficiently contained and retrieved, and also for increasing amounts of users executing queries against the database simultaneously. Aggregated spend database 304 contains spend data from across the totality of the business environment normalized to the universal taxonomy.

Spend taxonomy normalization tool 302 utilizes aggregated spend database 304 to store the normalized spend data from the plurality of clients. In addition, aggregated spend database 304 stores service provider spend data 312. Service provider spend data 312 is spend data for the service provider, which is aggregated with the spend data for the plurality of clients. The service provider provides the service of collecting the spend data and obtaining the cost savings for outsourced goods and services from external suppliers. In a preferred embodiment the service provider already uses the universal taxonomy, so normalization of service provider spend data 312 is unnecessary.

Furthermore, aggregated spend database 304 is coupled to supplier relational database 314. Supplier relational database 314 is a relational database that stores supplier data in a structured format. As a result, aggregated spend database 304 may also include other data relating to one or more external suppliers.

Aggregated spend database 304 stores data points with “tags,” which correlate the data points to associated clients, suppliers, commodity codes, geographies, and other reference data, which enables spend taxonomy normalization tool 302 to easily generate both standardized reports and fully customized query reports. In addition, in a preferred embodiment, spend taxonomy normalization tool 302 continuously analyzes the normalized client spend data in aggregated spend database 304 to produce spend reports 316 in real time. These real time spend reports provide continuous visibility of the total managed spend portfolio to sourcing teams to leverage cost savings. In addition, in a preferred embodiment, spend taxonomy normalization tool 302 continuously creates data summary tables in aggregated spend database 304 to enable virtually instantaneous on-demand real time reports. Thus, authorized users may pull these on-demand reports on a continuous real time basis for review.

Delivery of aggregated spend reports 316 is a critical component within spend taxonomy normalization system 300 to ensure that individual client's spend data is securely maintained and is not compromised. A rigorous access request process may be employed that automatically routes requests for access to both an employee user's direct manager, as well as the outsourcing business lead for a requesting user's geography. Depending on the job role of the requester, access may be granted for a single client, for multiple clients, with or without disclosing of the client's name, and, with or without disclosing the name of the supplier. In a preferred embodiment, the employee user's intranet identification (ID) may be aligned with a specific user group, which allows visibility to that particular spend data.

Spend reports 316 are generated after the successful consolidation of the spend data to aggregated spend database 304. For example, spend data may be collected twice monthly from the various clients, as well as the outsourced service delivery provider. Then, an e-mail notification may be sent to the reporting team signaling a successful load. An e-mail system database may be utilized to facilitate the reporting process. In addition, agents may be used to create batch files and scripts that execute queries to a secure web portal. Maintenance of the queries and reports may be performed as new clients are on-boarded. Also, direct access to aggregated spend database 304 and ad-hoc report requests may be available to users on a need to know basis.

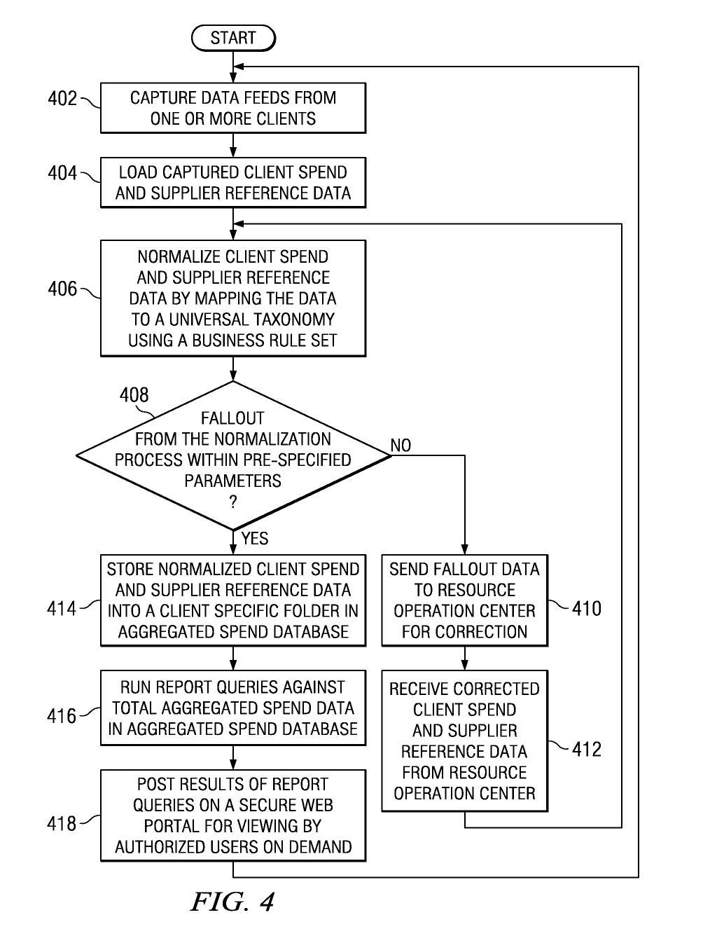

With reference now to FIG. 4, a flowchart illustrating an exemplary process for collecting, normalizing, and analyzing spend data is shown in accordance with an illustrative embodiment. The process shown in FIG. 4 may be implemented in a spend taxonomy normalization tool, such as, for example, spend taxonomy normalization tool 302 in FIG. 3.

As a brief summary of the process, a new client provides spend and reference data in its own native taxonomy. Subsequently, the spend taxonomy normalization tool maps this native taxonomy to an equivalent universal baseline taxonomy as recognized by the outsourced service delivery provider. This mapping of the client's native taxonomy enables the automated initial normalization of the first instance of the new client's spend data extract, which may yield a percentage of unrecognizable data elements. This initial normalization process includes self learning features so that if unknown data “terms” arrive as input, intelligent mapping algorithms may often find the correct match, and this new mapping is self learned for future occurrences. Those unrecognizable data elements “fallout” of the automated normalization process and are then manually aligned with the equivalent universal baseline taxonomy to ensure that those unrecognizable data elements pass subsequent automated normalization iterations. This closed-loop incremental reference data enhancement process ensures each subsequent iteration yields a reduced number of unrecognizable data elements, thereby increasing the percentage of spend data successfully normalized with each successive update. Once data quality reaches pre-specified parameters as defined by the outsourced service delivery provider, the data is automatically uploaded to a central spend data repository, where regularly scheduled standard report queries are run against the total aggregated data and results of the report queries are automatically posted to a secure web portal for on-demand viewing by authorized viewers.

The process begins when the spend taxonomy normalization tool captures data feeds from one or more clients, such as client 1 spend data feed 306, client 2 spend data feed 308, and/or client X spend data feed 310 in FIG. 3 (step 402). It should be noted that illustrative embodiments may receive the client data feeds on a continuous real time basis. Alternatively, illustrative embodiments may receive the client data feeds on a pre-determined timeline basis, such as, for example, once per hour, day, week, two weeks, or month. The data feeds include spend and supplier reference data for each of the one or more clients. Then, the spend taxonomy normalization tool loads the captured client spend data and supplier reference data (step 404).

After loading the spend and supplier reference data, the spend taxonomy normalization tool normalizes the spend and supplier reference data by mapping this data to a universal taxonomy using a business rule set (step 406). Subsequent to normalizing the spend and supplier reference data in step 406, the spend taxonomy normalization tool makes a determination as to whether “fallout” from the normalization process falls within pre-specified parameters (step 408). Fallout is unrecognized data that the spend taxonomy normalization tool cannot normalize using the existing business rule set. The pre-specified parameters may, for example, be standard geography codes (ISO-International Standards Organization) that were not included as part of the client's initial geography code reference data baseline, but are subsequently discovered in ongoing spend data feed normalization iterations. For example, if client's current spend data extract going through normalization includes the geography code ‘AR’ to represent spend originated in Argentina; and the respective client's initial geography code reference data baseline did not include geography code ‘AR’ to represent spend originated in Argentina, then the spend taxonomy normalization tool automatically maps that data element to the pre-specified parameter (‘AR’=Argentina) as recognized within the generic business rules of the spend taxonomy normalization tool.

If the fallout from the normalization process does not fall within the pre-specified parameters, no output of step 408, then the spend taxonomy normalization tool sends the fallout data to a resource operation center for manual correction (step 410). Subsequently, the spend taxonomy normalization tool receives corrected client spend and supplier reference data from the resource operation center (step 412). Thereafter, the process returns to step 406 where the spend taxonomy normalization tool normalizes the corrected spend and supplier reference data.

It should be noted that a preferred embodiment includes self-learning functionality whereby a percentage of unrecognized data fallout is automatically reprocessed and stored as a new business rule. The spend taxonomy normalization tool stores this new self-learned mapping rule in the business rule set for future automatic use. As a result, the spend taxonomy normalization tool may automatically correct unrecognized data fallout over time.

Returning again to step 408, if the fallout from the normalization process does fall within the pre-specified parameters, yes output of step 408, then the spend taxonomy normalization tool stores the normalized client spend and supplier reference data into a client specific folder in an aggregated spend database, such as aggregated spend database 304 in FIG. 3 (step 414). Then, the spend taxonomy normalization tool runs standard report queries against total aggregated data in the aggregated spend database (step 416). Afterward, the spend taxonomy normalization tool automatically posts results of the standard report queries on a secure Web portal for viewing by authorized users on-demand (step 418). Additionally, customer reports may be extracted on an ad-hoc basis by authorized parties with direct access to the aggregated spend database. Thereafter, the process returns to step 402 where the spend taxonomy normalization tool continues to receive client data feeds.

Thus, illustrative embodiments provide a computer implemented method, system, and computer usable program code for collecting, normalizing, and analyzing spend data in support of a multi-client procurement services outsourcing environment to drive cost savings. The invention may take the form of an entirely hardware embodiment, an entirely software embodiment, or an embodiment containing both hardware and software elements. In a preferred embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system. For the purposes of this description, a computer-usable or computer-readable medium may be any tangible apparatus that may contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example physical or wireless.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for processing spend data, the computer implemented method comprising:
responsive to capturing data feeds from one or more clients and a service provider, normalizing spend data contained within the data feeds by mapping the spend data to a common universal taxonomy using a business rule set to form normalized spend data;
storing the normalized spend data within an aggregated spend database;
running report queries against total aggregated spend data within the aggregated spend database; and
posting results of the report queries on a secure web portal for viewing by authorized users.

2. The computer implemented method of claim 1, further comprising:
determining whether fallout from the normalizing step is within pre-specified parameters;
responsive to determining that the fallout from the normalizing step is not within the pre-specified parameters, sending the fallout to a resource center for correction;
receiving corrected spend data from the resource center; and
normalizing the corrected spend data.

3. The computer implemented method of claim 1, wherein the total aggregated spend is analyzed on a continuous basis to continuously create data summary tables in the aggregated spend database in order to provide real time spend reports on demand.

4. The computer implemented method of claim 1, wherein the spend data contained within the data feeds are in disparate format and nomenclature taxonomies.

5. The computer implemented method of claim 1, wherein the spend data is data that relates to the amount of money a client spends on procuring outsourced goods and services from external suppliers.

6. The computer implemented method of claim 1, wherein the spend data includes reference data, and wherein the reference data includes commodity codes, currency data, supplier data, geography data, client hierarchy data, payment term data, contract data, and forecast data.

7. The computer implemented method of claim 1, wherein the business rule set includes self-learning rules.

8. The computer implemented method of claim 2, wherein the fallout is unrecognizable data elements.

9. The computer implemented method of claim 1, wherein the report queries include standardized report queries and customized report queries.

10. The computer implemented method of claim 1, wherein the aggregated spend database provides a comprehensive visibility of spend across multiple outsourced procurement clients to leverage cost savings to a service provider and to the multiple outsourced procurement clients.

11. A data processing system for processing spend data, comprising:
a bus system;
a storage device connected to the bus system, wherein the storage device includes a set of instructions; and
a processing unit connected to the bus system, wherein the processing unit executes the set of instructions to normalize spend data contained within data feeds from one or more clients and a service provider by mapping the spend data to a common universal taxonomy using a business rule set to form normalized spend data in response to capturing the data feeds, store the normalized spend data within an aggregated spend database, run report queries against total aggregated spend data within the aggregated spend database, and post results of the report queries on a secure web portal for viewing by authorized users.

12. The data processing system of claim 11, wherein the processing unit executes a further set of instructions to determine whether fallout from execution of the set of instructions to normalize the spend data contained within data feeds is within pre-specified parameters, send the fallout to a resource center for correction in response to determining that the fallout from the execution of the set of instructions to normalize the spend data contained within data feeds is not within the pre-specified parameters, receive corrected spend data from the resource center, and normalize the corrected spend data.

13. The data processing system of claim 11, wherein the total aggregated spend is analyzed on a continuous basis to continuously create data summary tables in the aggregated spend database in order to provide real time spend reports on demand.

14. The data processing system of claim 11, wherein the aggregated spend database provides a comprehensive visibility of spend across multiple outsourced procurement clients to leverage cost savings to a service provider and to the multiple outsourced procurement clients.

15. A computer program product for processing spend data, the computer program product comprising:
a computer usable medium having computer usable program code embodied therein, the computer usable medium comprising:
computer usable program code configured to normalize spend data contained within data feeds from one or more clients and a service provider by mapping the spend data to a common universal taxonomy using a business rule set to form normalized spend data in response to capturing the data feeds;
computer usable program code configured to store the normalized spend data within an aggregated spend database;
computer usable program code configured to run report queries against total aggregated spend data within the aggregated spend database; and
computer usable program code configured to post results of the report queries on a secure web portal for viewing by authorized users.

16. The computer program product of claim 15, further comprising:
computer usable program code configured to determine whether fallout from execution of the computer usable program code to normalize the spend data contained within data feeds is within pre-specified parameters, send the fallout to a resource center for correction in response to determining that the fallout from the execution of the computer usable program code to normalize the spend data contained within data feeds is not within the pre-specified parameters, receive corrected spend data from the resource center, and normalize the corrected spend data.

17. The computer program product of claim 15, wherein the spend data contained within the data feeds are in disparate format and nomenclature taxonomies.

18. The computer program product of claim 15, wherein the spend data is data that relates to the amount of money a client spends on procuring outsourced goods and services from external suppliers.

19. The computer program product of claim 15, wherein the business rule set includes self-learning rules.

20. The computer program product of claim 16, wherein the fallout is unrecognizable data elements.
